(19) United States
(12) Patent Application Publication
(10) Pub. No.: US 2015/0220533 A1
(43) Pub. Date: Aug. 6, 2015

(54) INFORMATION PROCESSING METHOD, AND INFORMATION PROCESSING SYSTEM

(71) Applicant: SHARP KABUSHIKI KAISHA, Osaka (JP)

(72) Inventor: Hideaki YAMADA, Osaka (JP)

(73) Assignee: SHARP KABUSHIKI KAISHA, Osaka (JP)

(21) Appl. No.: 14/609,089

(22) Filed: Jan. 29, 2015

(30) Foreign Application Priority Data
Jan. 31, 2014 (JP) 2014-017260

(51) Int. Cl. G06F 17/30; G06Q 30/02; H04L 29/08

(52) U.S. Cl. CPC G06F 17/3053; H04L 67/22; G06F 17/30386; G06Q 30/0256

(57) ABSTRACT

In one embodiment, an information processing method for an information processing apparatus includes, but is not limited to, the following processes. Identification information held by a display device is acquired. Viewing history information indicating a history of content viewed on the display device holding the identification information is acquired. The viewing history information and content detail information describing the details of the content for each segment making up the content is referenced. And Searching conditions related to the details of the segment making up the content viewed on the display device holding the identification information is extracted.

### BACKGROUND OF THE INVENTION

1. Field of the Invention

The present invention relates to an information processing method, and an information processing system.

Priority is claimed on Japanese Patent Application No. 2014-017260, filed Jan. 31, 2014, the content of which is incorporated herein by reference.

2. Description of the Related Art

There is a server that provides to a user advertising information related to content viewed by the user (for example, refer to Japanese Patent Application Publication No. 2003-331183). There is also an advertising distribution system that matches advertisements with personal information such as a browsing record without transmitting it from the terminal to the outside, so as to distribute advertising suited to the interests of the user (for example, refer to Japanese Patent Application Publication No. 2010-55597).

### PRIOR ART REFERENCES

### Patent Reference

### DISCLOSURE OF THE INVENTION

### Problems to be Solved by the Invention

What is conventionally known is distribution of advertising information related to the overall content viewed by a user. For example, there are users who watch a segment they like within one content but do not watch other segments. For this reason, even if advertising information related to the overall content watched by the user is distributed, there is a problem of not being able distribute advertising suitable for a user who watches only part of the segments.

The present invention has been made in consideration of the above-noted point, and has as an object the provision of an information processing apparatus, an information processing method, a program, an information processing system, and a display device capable of extracting more optimal searching conditions, even if content is only partially viewed.

### SUMMARY

In one embodiment, an information processing method for an information processing apparatus includes, but is not limited to, the following processes. Identification information held by a display device is acquired. Viewing history information indicating a history of content viewed on the display device holding the identification information is acquired. The viewing history information and content detail information describing the details of the content for each segment making up the content is referenced. And Searching conditions related to the details of the segment making up the content viewed on the display device holding the identification information is extracted.

In another embodiment, an information processing system includes, but not limited to, a display device, a viewing history information server apparatus, an information processing apparatus. The display device, wherein the display device comprises a display unit configured to display content, an identification information storage unit configured to store identification information, a viewing history transmitting unit configured to transmit viewing history information including a history of watching the content displayed by the display unit and the identification information, and an identification information transmitting unit configured to transmit the identification information stored by the identification information storage unit. The viewing history information server apparatus, wherein the viewing history information server apparatus comprises a server receiving unit configured to receive the viewing history information transmitted by the viewing history transmitting unit, a viewing history storage unit configured to store the viewing history information received by the server receiving unit, and a server transmitting unit configured to transmit the viewing history information stored by the viewing history storage unit. The information processing apparatus, wherein the information processing apparatus comprises an identification information acquisition unit configured to acquire the identification information transmitted from the display device, a viewing history information acquisition unit configured to acquire the viewing history information transmitted from the viewing history information server apparatus, and an extraction unit configured to reference the viewing history information acquired by the viewing history information acquisition unit and content detail information describing the details of the content of each segment make up the content, and extract search conditions related to the details of the segment making up the content viewed on the display device holding the identification information acquired by the identification information acquisition unit.

In another embodiment, an information processing method for a display device includes, but is not limited to, the following processes. Content is displayed. Identification information is stored. Viewing history information including a history of watching the content and the identification information is transmitted. The identification information is transmitted. A second content selected based on a search condition related to the details of the segment making up the content viewed on its own device, extracted by referencing the viewing history information and content detail information describing the detail of the content of each segment making up the content is received. The second content is displayed.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a simplified drawing showing an example of an information processing system according to a first embodiment.

FIG. 2 is a block diagram showing an example of the functional constitution of a display device according to the first embodiment.

FIG. 3 is a block diagram showing an example of the functional constitution of a viewing history information server apparatus according to the first embodiment.

FIG. 4 is a block diagram showing an example of the functional constitution of an information processing apparatus according to the first embodiment.

FIG. 5 is a simplified drawing showing an example of a viewing history database according to the first embodiment.

FIG. 6 is a simplified drawing showing an example of the content detail information of one segment stored in a content detail information database according to the first embodiment.

FIG. 7 is a simplified drawing showing an example of an extracted-keyword database according to the first embodiment.

FIG. 8 is a flowchart showing an operating procedure of an information processing apparatus according to the first embodiment.

FIG. 9 is a simplified drawing showing an example of extracted keywords for each identification information according to a second embodiment.

FIG. 10 is a simplified drawing showing an example of extracted keywords as keywords related to a segment of a broadcast program viewed in particular on the display device according to a second embodiment.

FIG. 11 is a simplified drawing showing an example of extracted keywords as keywords related to the details of a segment of a broadcast program viewed on the display device according to a third embodiment.

### DETAILED DESCRIPTION OF THE PREFERRED EMBODIMENTS

The present invention will now be described herein with reference to illustrative embodiments. The accompanying drawings explain an information processing apparatus, information processing method, program, information processing system, and display device in the embodiments. The size, the thickness, and the like of each illustrated portion might be different from those of each portion of an actual processing apparatus, and display device.

Those skilled in the art will recognize that many alternative embodiments can be accomplished using the teachings of the present invention and that the present invention is not limited to the embodiments illustrated herein for explanatory purposes.

### First Embodiment

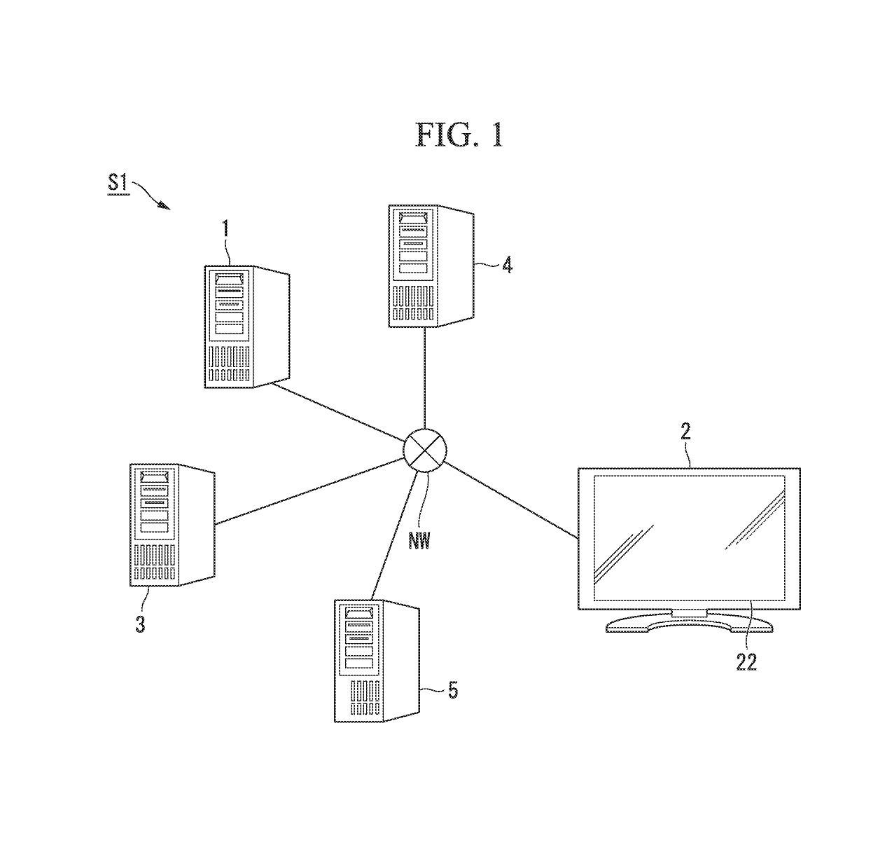

The first embodiment of the present invention will be described below. The simplified drawing of FIG. 1 shows an example of an information processing system S1 according to the first embodiment of the present invention. In the illustrated example, the information processing system S1 has an information processing apparatus 1, a display device 2, a viewing history information server apparatus 3, a content distribution server 4, and a program information providing apparatus 5.

The information processing apparatus 1, the viewing history information server apparatus 3, the content distribution server 4, and the program information providing apparatus 5 are, for example, server apparatuses having a generally known server function. The display device 2, for example, has a display unit 22 such as a television, a personal computer, a mobile telephone, a tablet, a smartphone, or a PDA (personal digital assistant). The information processing apparatus 1, the display device 2, the viewing history information server apparatus 3, the content distribution server 4, and the program information providing apparatus 5 are each connected by wireless or by cable to a network NW and can mutually communicate.

The network NW is an information communication network formed by, for example, a mobile telephone network, a PHS (Personal Handy-phone System) network, a VPN (virtual private network), a dedicated communication line network, a WAN (wide-area network), a LAN (local area network), or a PSTN (public switched telephone network), or may be a combination thereof.

The information processing apparatus 1 references a history of broadcast programs (content) viewed on the display device 2 holding the identification information and content detail information describing the details of the broadcast program for each segment of the broadcast program, and extracts keywords (searching conditions) related to the details of the content making up the broadcast program viewed on the display device 2 holding the identification information. The information processing apparatus 1, based on the extracted keywords, selects advertising (second content) that will be distributed to the display device 2.

The display device 2 receives a television broadcast and displays the broadcast program of the television broadcast on the display unit 22. The display device 2 receives advertising distributed from the content distribution server 4 and displays the received advertising on the display unit 22. The display device 2 transmits to the viewing history information server apparatus 3 viewing history information that includes the history of viewed broadcast program displayed on the display unit 22 and the held identification information. The identification information is held by the display device 2 and specifies the display device 2. The identification information may be device identification information unique to the display device 2. The identification information may be user identification information identifying a user using the display device 2. For example, if the identification information is user identification information, the user sets into the display device 2 user identification information identifying the user. The display device 2 stores the set user identification information as identification information.

In the following, the display of a broadcast program by the display device 2 will be called the watching of a broadcast program by a user of the display device 2. A person using the display device 2 and watching a broadcast program will be referred to as a viewer.

The viewing history information server apparatus 3 stores a viewing history database. The viewing history database stores a viewing history of broadcast programs watched on the display device 2, which holds the identification information. The details of the viewing history database will be described later. The viewing history information server apparatus 3 stores the viewing history information transmitted from the display device 2 into the viewing history database. The viewing history information server apparatus 3 also transmits the viewing history information stored in the viewing history database to the information processing apparatus 1. The content distribution server 4, based on instructions from the information processing apparatus 1, distributes advertising selected by the information processing apparatus 1 to the display device 2.

The program information providing apparatus 5 stores a content detail information database. The content detail information database stores various information of broadcast programs. The details of the content detail information database will be described later. The program information providing apparatus 5 transmits the data stored in the content detail information database to the information processing apparatus 1.

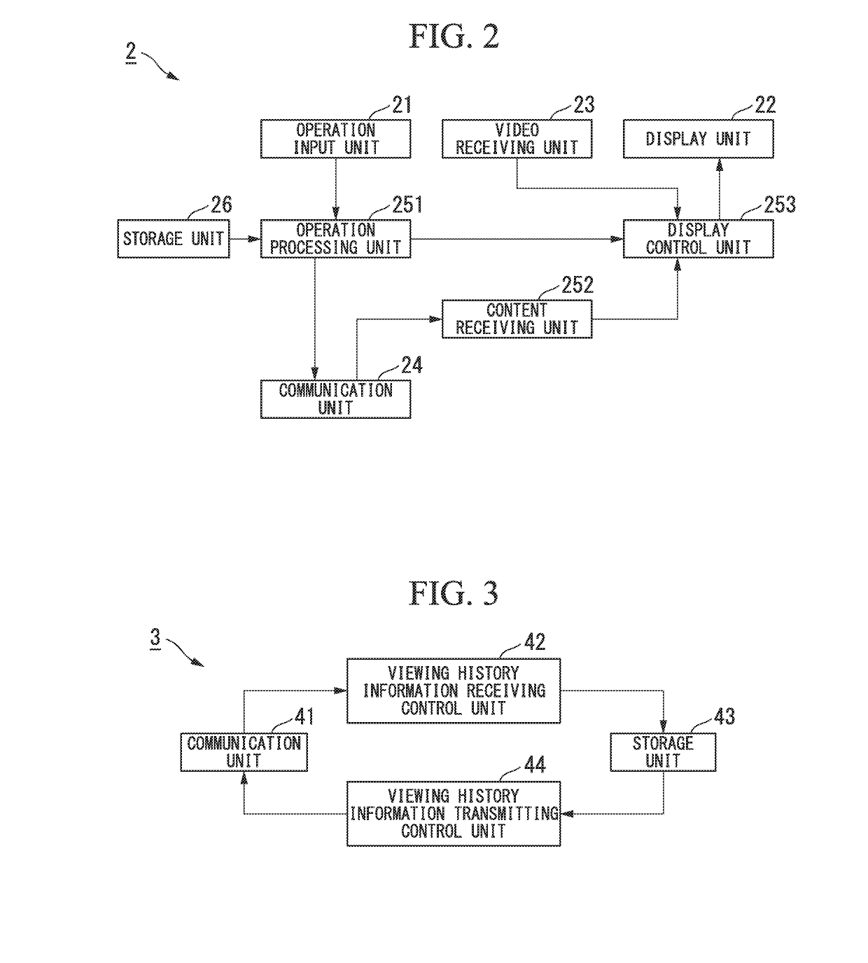

Next, the constitution of the display device 2 will be described. The block diagram of FIG. 2 shows an example of the functional constitution of the display device 2. In the illustrated example, the display device 2 has an operation input unit 21, a display unit 22, a video receiving unit 23, a communication unit 24 (viewing history transmitting unit, identification information transmitting unit, and receiving unit), a storage unit 26, an operation processing unit 251, a content receiving unit 252, and a display control unit 253. The display device 2 has the function of a generally known television receiver.

The display device 2 has a CPU (central processing unit) and a storage device. The storage device, for example, has a HDD (hard disk drive), a flash memory, an EEPROM (electrically erasable programmable read-only memory), a ROM (read-only memory) or a RAM (random-access memory) and stores firmware and application programs, such as various program for execution by the CPU of the terminal device 2 and the results of processing executed by the CPU. For example, by executing programs stored in the storage unit, the CPU operates as the operation processing unit 251, the content receiving unit 252, and the display control unit 253.

The operation input unit 21 accepts from viewers input of operations to the display device 2 and, for example, accepts input of operations via an input device such as a television remote controller.

The display unit 22 has a display device 2 such as a liquid-crystal display or an organic EL (electroluminescence) display. The display unit 22 displays a broadcast program received by the video receiving unit 23 and advertising received by the content receiving unit 252 from the content distribution server 4.

The video receiving unit 23 has a television tuner and receives a broadcast program as a television broadcast. The communication unit 24 has a communication interface and communicates with other devices such as the information processing apparatus 1, the viewing history information server apparatus 3, the content distribution server 4, and the program information providing apparatus 5.

The operation processing unit 251 analyzes inputs accepted by the operation input unit 21 and executes processing in response to the inputs. For example, if input of a channel-switching operation is accepted by the operation input unit 21, the operation processing unit 251 outputs to the display control unit 253 the channel information after the switching.

If, for example, the operation input unit 21 accepts input of an operation to switch the power on, the operation processing unit 251, via the communication unit 24, transmits to the viewing history information server apparatus 3 the time of acceptance of the input of an operation to switch the power on, the currently set channel information, and the identification information stored by the storage unit 26. Also, for example, if the operation input unit 21 accepts input of an operation to switch the power off, the operation processing unit 251, via the communication unit 24, transmits to the viewing history information server apparatus 3 the time of acceptance of an input of the operation to switch the power off, and the identification information stored by the storage unit 26. Also, for example, if the operation input unit 21 accepts input of an operation to switch the channel, the operation processing unit 251, via the communication unit 24, transmits to the viewing history information server apparatus 3 the time of acceptance of the input of the operation to switch the channel, the channel information after the switching, and the identification information stored by the storage unit 26.

Thus, the operation processing unit 251, via the communication unit 24, transmits to the viewing history information server apparatus 3 viewing history information including the history of watching broadcast programs displayed on the display unit 22 and the held identification information.

The display control unit 253 causes the display unit 22 to display a broadcast program received by the video receiving unit 23 and advertising and the like received by the content receiving unit 252. For example, if channel information after the switching is input from the operation processing unit 251, the display control unit 253 switches the broadcast program displayed on the display unit 22, based on the channel information after the switching. Also, for example, if the content receiving unit 252 receives advertising, the display control unit 253 causes the display unit 22 to display the advertising. The display control unit 253 may, for example, erase an advertisement after a certain amount of time has elapsed from the display of advertising on the display unit 22. The certain amount of time may be pre-established or may be arbitrarily settable.

Next, the constitution of the viewing history information server apparatus 3 will be described. The block diagram of FIG. 3 shows an example of the functional constitution of the viewing history information server apparatus 3. In the illustrated example, the viewing history information server apparatus 3 has a communication unit 41 (server receiving unit and server transmitting unit), a viewing history information receiving control unit 42, a storage unit 43 (viewing history storage unit), and a viewing history information transmitting control unit 44.

The viewing history information server apparatus 3 has a CPU and a storage device. The storage device, for example, has a HDD, a flash memory, an EEPROM a ROM or a RAM and stores firmware and application programs, such as various programs for execution by the CPU and the results of processing executed by the CPU. For example, by executing programs stored in the storage unit, the CPU operates as the viewing history information receiving unit 42 and the viewing history information transmitting unit 44.

The communication unit 41 has a communication interface and communicates with other devices such as the information processing apparatus 1, the display device 2, the content distribution server 4, and the program information providing apparatus 5. The viewing history information receiving control unit 42 receives viewing history information transmitted from the display device 2, via the communication unit 41 and stores the received viewing history information into the viewing history database stored by the storage unit 43.

The storage unit 43 has, for example, a hard-disk drive and stores the viewing history database. The viewing history information transmitting control unit 44, via the communication unit 41, transmits viewing history information stored in the viewing history database of the storage unit 43 to the information processing apparatus 1.

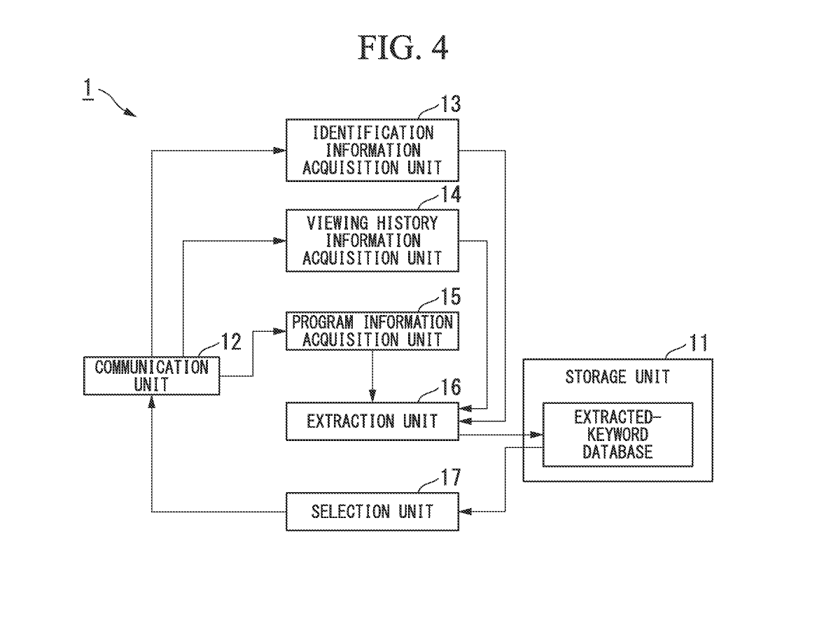

Next, the constitution of the information processing apparatus 1 will be described. The block diagram of FIG. 4 shows an example of the functional constitution of the information processing apparatus 1. In the illustrated example, the information processing apparatus 1 has a storage unit 11, a communication unit 12, an identification information acquisition unit 13, a viewing history information acquisition unit 14, a program information acquisition unit 15, an extraction unit 16, and a selection unit 17.

The information processing apparatus 1 has a CPU and a storage device. The storage device, for example, has a hard disk drive, a flash memory, an EEPROM, a ROM or a RAM and stores firmware and application programs such as various programs for execution by the CPU and the results of processing executed by the CPU. For example, by executing programs stored in the storage device, the CPU operates as the identification information acquisition unit 13, the viewing history information acquisition unit 14, the program information acquisition unit 15, the extraction unit 16, and the selection unit 17.

The storage unit 11 has a hard-disk drive, a flash memory, an EEPROM, a ROM, or a RAM and stores data used in various units of the information processing apparatus 1. The storage unit 11 stores an extracted-keyword database, the details of which will be described later.

The communication unit 12 has a communication interface and communicates with other devices such as the display device 2, the viewing history information server apparatus 3, the content distribution server 4 and the program information providing apparatus 5. The identification information acquisition unit 13 acquires identification information from the display device 2 via the communication unit 12. The viewing history information acquisition unit 14, via the communication unit 12, acquires viewing history information from the viewing history information server apparatus 3. The program information acquisition unit 15, via the communication unit 12, acquires content detail information from the program information providing apparatus 5.

The extraction unit 16 references viewing history information acquired by the viewing history information acquisition unit 14 and content detail information acquired by the program information acquisition unit 15 and extracts keywords (searching conditions) related to the details of a segment making up a broadcast program viewed on the display device 2 holding the identification information acquired by the identification information acquisition unit 13. The extraction unit 16 stores the extracted keywords, in association with the identification information, into the extracted-keyword database. The details of the method of extracting keyword will be described later.

The selection unit 17, based on the keywords of the identification information stored in the extracted-keyword database, selects advertising to distribute to the display device 2 holding the identification information. The details of the method of selecting advertising to be distributed will be described later. The selection unit 17, via the communication unit 12, transmits to the content distribution server 4 an instruction to distribute advertising of a selected type.

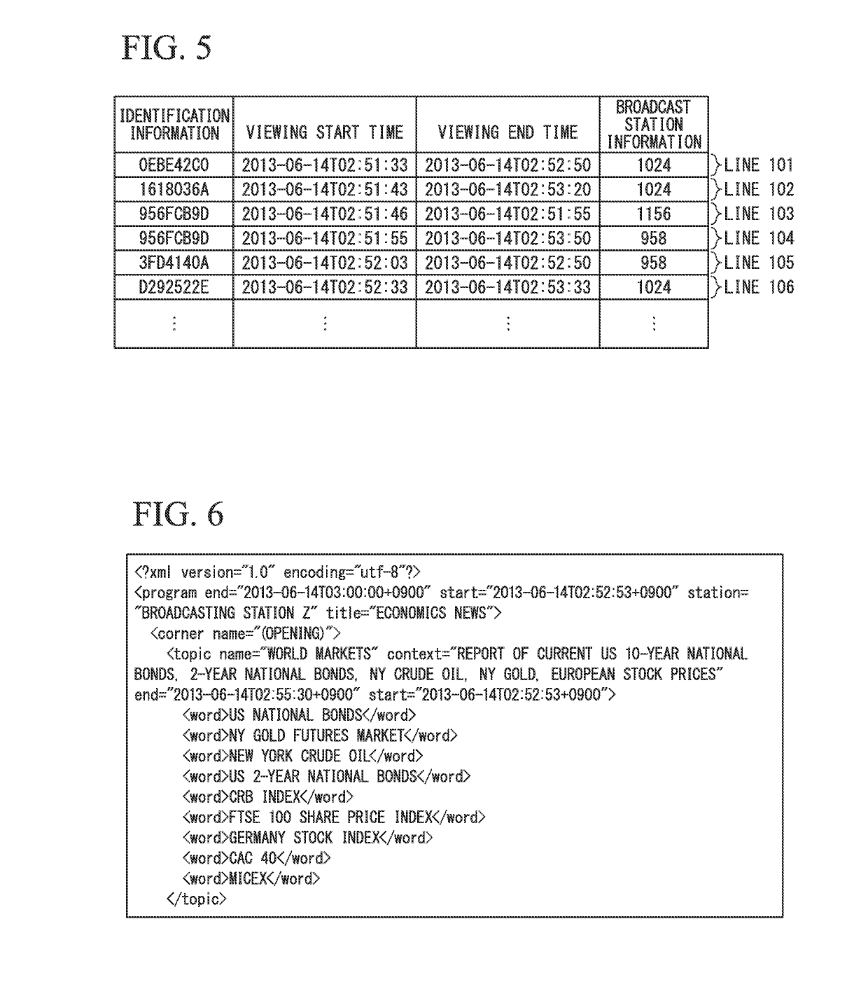

Next, the viewing history database stored by the storage unit 43 of the viewing history information server apparatus 3 will be described. The simplified drawing of FIG. 5 shows an example of the viewing history database. The viewing history database has the data items “Identification information”, “Viewing start time”, “Viewing end time”, and “Broadcast station information”, and stores the data of each item in association with one another on each line.

The data item “Identification information” stores the identification information identifying the display device 2. The data item “Viewing start time” stores the starting time of viewing a broadcast program. The data item “Viewing end time” stores the ending time of viewing a broadcast program. The data item “Broadcast station information” stores the broadcast station ID identifying the broadcast station broadcasting the viewed broadcast program.

In the illustrated example, on line 101, the value stored in the data item “Identification information” is “OEBE42C0”, the value stored in the data item “Viewing start time” is “2013-06-14T02:51:33”, the value stored in the data item “Viewing end time” is “2013-06-14T02:52:50”, and the value stored in the data item “Broadcast station information” is “1024”. This indicates that, from 2 h:51 m:33 s on Jun. 14, 2013 until 2 h:52 m:50 s on Jun. 14, 2013, a user using the display device 2 identified by the identification information “OEBE42C0” viewed a broadcast program broadcast by a broadcast station identified by the broadcast station ID “1024”. With regard to the other lines, they are as illustrated.

Next, the content detail information database stored by the program information providing apparatus 5 will be described. The simplified drawing of FIG. 6 shows an example of the content detail information for one segment stored in the content detail information database. The content detail information database stores the content detail information for each segment making up a broadcast program in XML format.

For example, the content detail information has, as data items, “?xml version”, “encoding”, “program end”, “start”, “station”, “title”, “corner name”, “topic name”, “context”, “end”, “start”, and “word”. The data item “?xml version” stores the version of XML. The data item “encoding” stores the character encoding method. The data item “program end” stores the broadcast ending time of the broadcast program. The data item “start” stores the broadcast starting time of the broadcast program. The data item “station” stores the name of the broadcast station broadcasting the broadcast program. The data item “title” stores the name of the broadcast program. The data item “corner name” stores the name of a segment. The data item “topic name” stores the name of the topic making up the segment. The data item “context” stores the details of the topic making up the segment. The data item “end” stores the broadcast ending time of the topic making up the segment. The data item “start” stores the broadcast starting time of the topic making up the segment. The data item “word” stores keywords related to the details of the topic making up the segment.

In the illustrated example, the value stored in the data item “?xml version” is “1.0, and the value stored in the data item “encoding” is “utf-8”. This indicates that the XML version is 1.0 and the character encoding method is UTF-8. The value stored in the data item “program end” is “2013-06-14T03:00:00+0900”, the value stored in the data item “start” is “2013-06-14T02:52:53+0900”, the value stored in the data item “station” is “Broadcasting station Z”, and the value stored in the data item “title” is “Economics news”, this indicating that the broadcast program name is “Economics News”, and the broadcast station name is “Broadcast station Z”, the broadcast of which started at “2013-06-14T02:52:53+0900” and ended at “2013-06-14T03:00:00+0900”.

Also, the value stored in the data item “corner name” is “(Opening)”, this indicating that the segment name is “(Opening)”. The value stored in the data item “topic name” is “World Markets”, and the value stored in the data item “context” is “Report of Current US 10-year national bonds, 2-year national bonds, NY crude oil, NY gold, European stock prices”, the value stored in the data item “end” is “2013-06-14T02:55:30+0900”, the value stored in the data item “start” is “2013-06-14T02:52:53+0900”, and the values stored in the data item “word” are “US national bonds”, “NY gold futures market”, “New York crude oil”, “US 2-year national bonds”, “CRB index”, “FTSE 100 share price index”, “Germany stock index”, “CAC 40”, and “MICEX”.

The above indicates that the name of the topic making up the segment “(Opening)” within the broadcast program named “Economics News” is “World Markets”. This also indicates that the details of the topic “World Markets” making up the “(Opening)” segment are “Current US 10-year national bonds, 2-year national bonds, NY crude oil, NY gold, European stock prices reported”, the starting time of the broadcast is “2013-06-14T02:52:53+0900”, the ending time of the broadcast is “2013-06-14T02:55:30+0900”, and the related keywords stored in the data item are “US national bonds”, “NY gold futures market”, “New York crude oil”, “US 2-year national bonds”, “CRB index”, “FTSE 100 share price index”, “Germany stock index”, “CAC 40”, and “MICEX”.

Although the content detail information for only one segment stored in the content detail information database are shown in FIG. 6, the content detail information database actually stores the content detail information for each segment of programs broadcast nationwide or over an entire region.

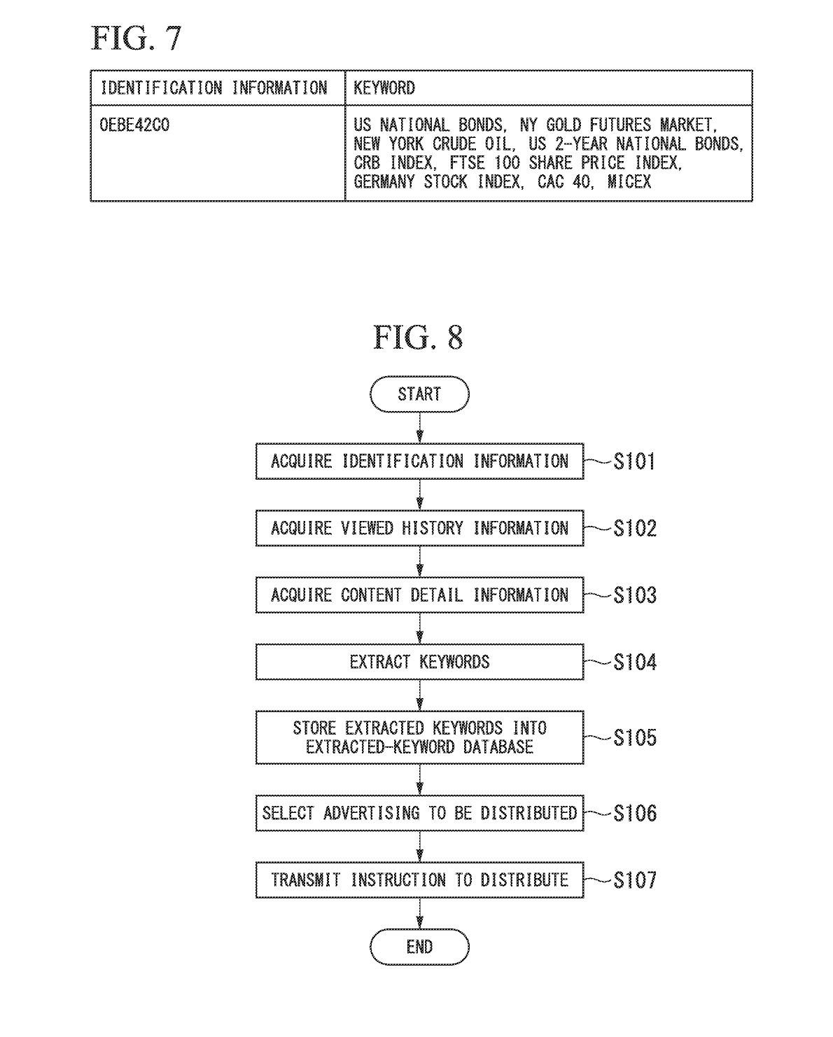

Next, the extracted-keyword database stored by the storage unit 11 of the information processing apparatus 1 will be described. The simplified drawing of FIG. 7 shows an example of the extracted-keyword database. The extracted-keyword database has the data items “Identification information” and “Keyword” and stores data of each data item associated in each line.

The data item “Identification information” stores the identification information specifying the display device 2. The data item “Keyword” stores keywords related to a segment making up a broadcast program watched on the display device 2. In the illustrated example, in line 201, the value stored in “Identification information” data item is “OEBE42C0” and the value stored in the “Keyword” data item is “US national bonds, NY gold futures market, New York crude oil, US 2-year national bonds, CRB index, FTSE 100 share price index, Germany stock index, CAC 40, and MICEX”. This indicates that the keywords related to the segment making up the program watched on the display device 2 specified by the identification information “OEBE42C0” are “US national bonds”, “NY gold futures market”, “New York crude oil”, “US 2-year national bonds”, “CRB index”, “FTSE 100 share price index”, “Germany stock index”, “CAC 40”, and “MICEX”.

Next, the method of extracting search conditions related to the details of a segment making up a broadcast program watched on the display device 2 holding the identification information will be described. As described above, the program information providing apparatus 5 stores a content detail information database, which stores the content detail information for a segment making up a broadcast program. The viewing history information server apparatus 3 stores a viewing history database, which stores a viewing history of a program watched on the display device 2. Given this, the information processing apparatus 1 references the content detail information database and the viewing history database and extracts keywords related to a segment making up a program watched on the display device 2 holding the identification information. The information processing apparatus 1 also stores the extracted keywords into the extracted-keyword database stored by the storage unit 11.

For example, the example illustrated in FIG. 5 indicates that on the display device 2 holding the identification information “OEBE42C0” a program broadcast by a broadcast station identified by the broadcast station ID “1024” was watched from 2 h:50 m:50 s on Jun. 14, 2013 until 2 h:52 m:55 s on Jun. 14, 2013. In the example illustrated in FIG. 6, the keywords related to the segment making up the program broadcast from 2 h:50 m:50 s on Jun. 14, 2013 until 2 h:52 m:55 s on Jun. 14, 2013 by the broadcast station identified by the broadcast station ID “1014” are “US national bonds”, “NY gold futures market”, “New York crude oil”, “US 2-year national bonds”, “CRB index”, “FTSE 100 share price index”, “Germany stock index”, “CAC 40”, and “MICEX”. Therefore, the information processing apparatus 1 extracts “US national bonds”, “NY gold futures market”, “New York crude oil”, “US 2-year national bonds”, “CRB index”, “FTSE 100 share price index”, “Germany stock index”, “CAC 40”, and “MICEX” as search conditions (keywords) related to the segment details making up the program watched on the display device 2 holding the identification information “OEBE42C0”.

In the same manner, if another broadcast program is watched on the display device 2 holding the identification information “OEBE42C0”, the information processing apparatus 1 extracts keywords related to a segment making up the other broadcast program watched on the display device 2. Therefore, the more segments that are watched on the display device 2, the more keywords are extracted by the information processing apparatus 1.

Next, the method of the information processing apparatus 1 selecting advertising to distribute to the display device 2 will be described. In the present embodiment, the storage unit 11 of the information processing apparatus 1 stores the extracted-keyword database. The selection unit 17 selects the type of advertising to be distributed to the display device 2 based on the keywords stored in the extracted-keyword database.

For example, if the storage unit 11 stores the extracted-keyword database shown in FIG. 7, the selection unit 17 selects the type of advertising with a high level of relevance to “US national bonds”, “NY gold futures market”, “New York crude oil”, “US 2-year national bonds”, “CRB index”, “FTSE 100 share price index”, “Germany stock index”, “CAC 40”, and “MICEX” as the type of advertising to be distributed to the display device 2 holding the identification information “OEBE42C0”.

A conventionally known searching method may be used as a method of selecting advertising having a high level of relevance to the keywords. For example, the selection unit 17 may select advertising that includes all of the keywords “US national bonds”, “NY gold futures market”, “New York crude oil”, “US 2-year national bonds”, “CRB index”, “FTSE 100 share price index”, “Germany stock index”, “CAC 40”, and “MICEX” as the type of advertising to be distributed to the display device 2 or may select advertising that includes any of the keywords “US national bonds”, “NY gold futures market, “New York crude oil”, “US 2-year national bonds”, “CRB index”, “FTSE 100 share price index”, “Germany stock index”, “CAC 40”, and “MICEX” as the type of advertising to distribute to the display device 2.

In this manner, the information processing apparatus 1 can select advertising having a high level of relevance to the details of a segment making up a program watched on the display device 2.

Next, the operating procedure of the information processing apparatus 1 will be described. The flowchart of FIG. 8 shows the operating procedure of the information processing apparatus 1.

(Step S101) The identification information acquisition unit 13, via the communication unit 24, acquires from the display device 2 to which distribution is to be done the identification information held by the display device 2, after which processing proceeds to step S102.

(Step S102) The viewing history information acquisition unit 14, via the communication unit 24, acquires the viewed history information from the viewing history information server apparatus 3, after which processing proceeds to step S103.

(Step S103) The program information acquisition unit 15, via the communication unit 24, acquires content detail information from the program information providing apparatus 5, after which processing proceeds to step S104.

(Step S104) The extraction unit 16 references the viewing history information acquired by the processing at step S102 and the content detail information acquired by the processing at step S103 and extracts keywords related to the details of a segment making up a broadcast program watched on the display device 2 holding the identification information acquired by the processing at step S101, using the keyword extraction method as described above, after which processing proceeds to step S105.

(Step S105) The extraction unit 16 stores the keywords extracted by the processing at step S104 into the extracted-keyword database stored by the storage unit 11, after which processing proceeds to step S106.

(Step S106) The selection unit 17, based on the keywords stored in the extracted-keyword database by the processing at step S105, selects advertising to be distributed to the display device 2, using the advertising selection method as described above, after which processing proceeds to step S107.

(Step S107) The selection unit 17 transmits to the content distribution server 4 an instruction to distribute the selected the type of advertising, after which processing ends. If the content distribution server 4 receives a distribution instruction, it distributes the advertising selected by the information processing apparatus 1 to the display device 2, based on the received distribution instruction.

As described above, according to the present embodiment, the information processing apparatus 1 acquires identification information held by the display device 2 from the display device 2 to which advertising is to be distributed. The information processing apparatus 1 also acquires viewing history information indicating broadcast program history watched on the display device 2 holding the identification information.

The information processing apparatus 1 references the acquired viewing history information and content detail information describing the detail of each segments making up the broadcast programs and extracts keywords related to the segment detail making up the broadcast programs viewed on the display device 2 to which advertising is to be distributed, thereby enabling extraction of the optimum keywords for selection of advertising to be distributed, for example, even if only a part of a broadcast program is viewed. The information processing apparatus 1 can select the type of advertisement to be distributed to the display device 2 based on the extracted keywords.

### Second Embodiment

Next, the second embodiment of the present invention will be described. The difference in the present embodiment with respect to the first embodiment is that, when keywords are extracted with respect to a display device 2 holding a certain identification information, narrowing down is done by using the keywords of a display device 2 holding different identification information.

The constitution of the information processing system S1 in the present embodiment is the same as the constitution of the information processing system S1 in the first embodiment. The information processing apparatus 1, the display device 2, the viewing history information server apparatus 3, the content distribution server 4, and the program information providing apparatus 5 have the same constitutions as the various devices in the first embodiment.

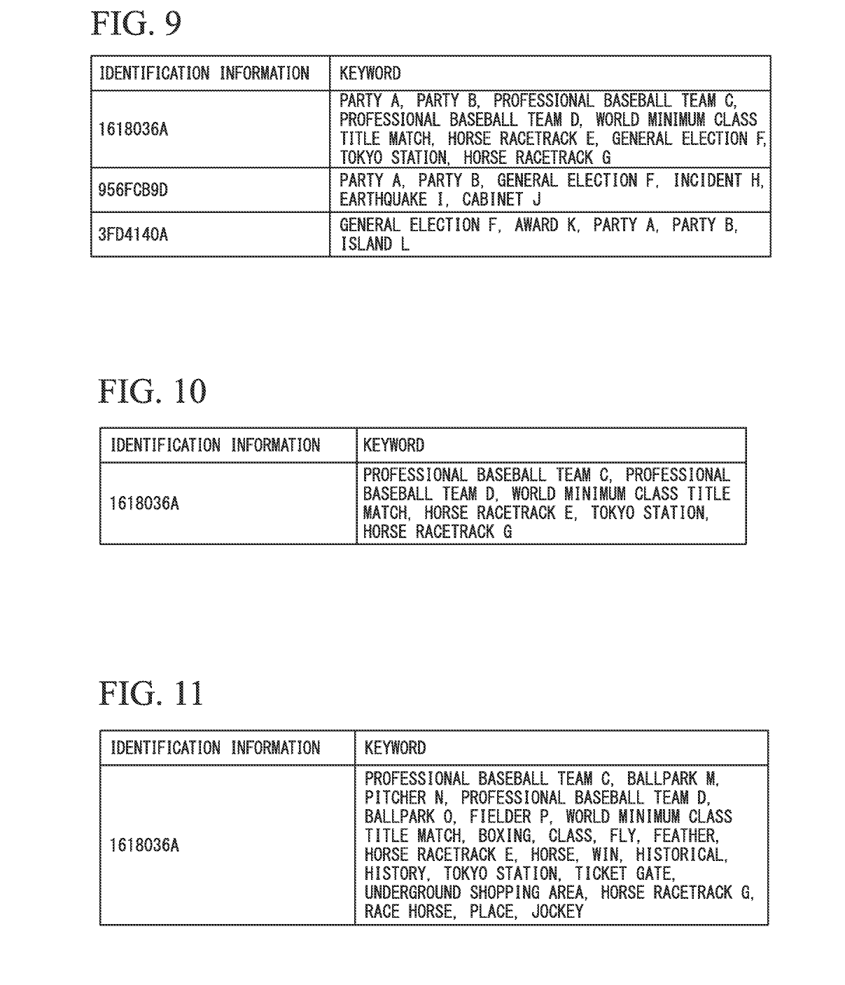

Next, the method of extracting keywords related to the detail of a segment making up a broadcast program viewed on the display device 2 holding the identification information will be described. The simplified drawing of FIG. 9 shows an example of keywords extracted for each identification information, using the keyword extraction method of the first embodiment.

In the illustrated example, the keywords related to segments making up a broadcast program viewed on the display device 2 identified by the identification information “1618036A” are “Party A”, “Party B”, “Professional baseball team C”, “Professional baseball team D”, “World minimum class title match”, “Horse racetrack E”, “General election F”, “Tokyo station”, and “Horse racetrack G”.

In the illustrated example, the keywords related to segments making up a broadcast program viewed on the display device 2 identified by the identification information “956FCB9D” are “Party A”, “Party B”, “General election F”, “Incident H”, “Earthquake I”, and “Cabinet J”.

In the illustrated example, the keywords related to segments making up a broadcast program viewed on the display device 2 identified by the identification information “3FD4140A” are “General election F”, “Award K”, “Party A”, “Party B”, and “Island L”.

In the above-described example, there are keywords common to each identification information. The words common to each identification information are general keywords. The keywords extracted for only specific identification information are related to the segment watched on only the display device 2 holding that identification information. Given this, in the present embodiment, when extracting keywords related to the details of segments making up a broadcast program watched on a display device 2 to which advertising is to be distributed, the keywords extracted by the method of the first embodiment are narrowed down to keywords related to segments of a broadcast program watched particularly on a display device 2 to which advertising is to be distributed.

That is, the extraction unit 16, narrows down the keywords having a high frequency of occurrence as keywords related to segments viewed on a display device 2 holding the identification information acquired by the identification information acquisition unit 13, with keywords having a low frequency of occurrence as keywords related to segments viewed on a display device 2 having identification information that is different from the identification information acquired by the identification information acquisition unit 13 taken as keywords related to a segment of a broadcast program viewed in particular on a display device 2 to which advertising will be distributed.

The method of narrowing down the keywords extracted by the method of the first embodiment to keywords related to segments of a broadcast program watched on a display device 2 to which advertising will be distributed. In the present embodiment, the keywords are narrowed down using TF-IDF method.

The TF (term frequency) is the frequency of occurrence of a keyword with respect to a display device 2 holding a specific identification information, and DF (document frequency) is the frequency of occurrence of a keyword with respect to a plurality of display devices 2. The IDF (inverse document frequency) can be calculated as log (N/DF) (where N is the total number of identification information). The larger is DF, the smaller is the value of IDF. Also, the greater the rarity of occurrence of only keywords with respect to a display device 2 holding a specific identification information, the larger is the value of IDF. TF-IDF is the product of TF and IDF. The value of TF-IDF becomes large when keywords with respect to a display device 2 holding specific identification information occur frequently and keywords with respect to a display device 2 holding a different identification information do not occur so frequently.

The extraction unit 16 calculates the value of TF-IDF of keywords extracted by the method of the first embodiment. The extraction unit 16 extracts keywords having a TF-IDF value exceeding a prescribed threshold as keywords related to segments of a broadcast program watched in particular on a display device 2 to which advertising will be distributed. The extraction unit 16 stores the extracted keywords into the extracted-keyword database stored by the storage unit 11.

The method of narrowing down the keywords is not limited to that noted above. For example, the keywords extracted by the method of the first embodiment may be narrowed down by extracting a prescribed number of keywords in descending order of TF-IDF value as keywords related to a segment of a broadcast program watched in particular on a display device 2 to which advertising will be distributed.

The simplified drawing of FIG. 10 in the present embodiment shows an example of keywords extracted as keywords related to a segment of a broadcast program watched in particular on a display device 2 to which advertising will be distributed.

In the illustrated example, “Profession baseball team C”, “Professional baseball team D”, “World minimum class title match”, “Horse racetrack E”, “Tokyo station”, and “Horse racetrack G” are indicated as keywords related to a segment making up a broadcast program watched on a display device 2 specified by the identification information “1618036A”. In this manner, only keywords related to the segment of a broadcast program watched in particular on a display device 2 to which advertising will be distributed are extracted from the keywords shown in FIG. 9.

As described above, according to the present embodiment, when extracting keywords related to the details of segments making up a broadcast program watched on a display device 2 having identification information “1618036A” to which advertising will be distributed, the keywords extracted by the method of the first embodiment are narrowed down to keywords related to segments of a broadcast program watched in particular on a display device 2 to which advertising will be distributed. This enables extraction of more optimal keywords in accordance with the watched content. The information processing apparatus 1 can select the type of advertising to be distributed to the display device 2, based on the extracted keywords.

### Third Embodiment

Next, the third embodiment of the present invention will be described. The constitution of the information processing system S1 in the present embodiment is the same as the constitution of the information processing system S1 in the second embodiment. The constitutions of the information processing apparatus 1, the display device 2, the viewing history information server apparatus 3, the content distribution server 4, and the program information providing apparatus 5 are the same as each device in the second embodiment.

The difference in the present embodiment with respect to the second embodiment is that keywords related to keywords extracted in the second embodiment are also extracted as keywords related to the details of segments making up a broadcast program viewed on a display device 2 to which advertising is to be distributed. For example, in the method of the second embodiment, keywords extracted by the method of the first embodiment are narrowed down to keywords related to a segment of a broadcast program watched in particular on a display device 2 to which advertising will be distributed. In this case, the number of keywords could be reduced.

Given the above, in the present embodiment, keywords related to the narrowed-down keywords are extracted as keywords related to the details of a segment making up a broadcast program watched on the display device 2. For example, the extraction unit 16 performs associative searching regarding keywords narrowed-down by the method of the second embodiment. The extraction unit 16 then extracts the keywords obtained as the search results as keywords related to the details of a segment making up a broadcast program that was watched on the display device 2. Also, for example, the extraction unit 16 references a thesaurus and searches for phrase related to the narrowed-down keywords. The extraction unit 16 then extracts the phrases obtained as search results as keywords related to the details of a segment making up a broadcast program that was watched on the display device 2.

The simplified drawing of FIG. 11 shows an example, in the present embodiment, of keywords related to keywords shown in FIG. 10 extracted as keywords related to the details of a segment making up a broadcast program watched on the display device 2.

In the illustrated example, “Professional baseball team C”, “Ballpark M”, “Pitcher N”, “Professional baseball team D”, “Ballpark O”, “Fielder P”, “World minimum class title match”, “Boxing”, “Class”, “Fly”, “Feather”, “Horse racetrack E”, “Horse”, “Win”, “Historical”, “History”, “Tokyo station”, “Ticket gate”, “Underground shopping area”, “Horse racetrack G”, “Race horse”, “Place”, and “Jockey” are indicated as keywords related to a segment making up a broadcast program watched on the display device 2 identified by the identification information “1618036A”.

In the illustrated example, the extraction unit 16 extracts “Ballpark M” and “Pitcher N” as keywords related to “Professional baseball team C” and extracts “Ballpark O” and “Pitcher P” as keywords related to “Professional baseball team D”. The extraction unit 16 extracts “Boxing”, “Class”, “Fly”, and “Feather” as keywords related to “World minimum class title match”, extracts “Horse”, “Win”, “Historical”, and “History” as keywords related to “Horse racetrack E” extracts “Ticket gate” and “Underground shopping area” as keywords related to “Tokyo station”, and extracts “Racehorse”, “Location” and “Jockey” as keywords related to “Horse racetrack G”. As described above, the information processing apparatus 1 extracts keywords related to narrowed-down keywords as keywords related to detail of a segment making up a broadcast program watched on the display device 2. Therefore, the information processing apparatus 1 can extract more keywords as keywords related to the details of a segment making up a broadcast program watched on the display device 2. The information processing apparatus 1 can select the type of advertising to be distributed to the display device 2 based on the extracted keywords.

### Fourth Embodiment

Next, the fourth embodiment of the present invention will be described. The constitution of the information processing system S1 of the present embodiment is the same as the constitution of the information processing system S1 in the first embodiment. The constitutions of the information processing apparatus 1, the display device 2, the viewing history information server apparatus 3, the content distribution server 4, and the program information providing apparatus 5 are the same as the various devices in the first embodiment.

The difference in the present embodiment from the first embodiment is that only keywords related to a segment watched for more than a prescribed amount of time are extracted in the present embodiment as keywords related to the details of a segment making up a broadcast program watched on the display device 2 holding the identification information.

For example, before a viewer decides on a broadcast program to watch, he or she switches the channel every several seconds or every several tens of seconds, watching the program broadcast on each of the channels. The broadcast programs watched when this is done are not necessarily broadcast programs in which the viewer is interested. Given this, the extraction unit 16 extracts only keywords related to segments viewed for more than a prescribed amount of time as keywords related to the details of a segment making up a broadcast program watched on the display device 2 holding the identification information. This enables the information processing apparatus 1, for example, to more optimally extract keywords used in selecting advertising to be distributed. The information processing apparatus 1 can select the type of advertising to be distributed to the display device 2 based on the extracted keywords. The prescribed amount of time may be pre-established, or may be arbitrarily settable.

### Fifth Embodiment

Next, the fifth embodiment of the present invention will be described. The constitution of the information processing system S1 of the present embodiment is the same as the information processing system S1 in the first embodiment. The constitutions of the information processing apparatus 1, the display device 2, the viewing history information server apparatus 3, the content distribution server 4, and the program information providing apparatus 5 are the same as the various devices in the first embodiment.

The difference in the present embodiment from the first embodiment is that the extraction unit 16 in the present embodiment extracts only keywords that occur a large number of times as keywords relative to the details of a segment making up a broadcast program watched on the display device 2 holding the identification information.

For example, if there is a large number of viewing histories, the number of keywords extracted based on the viewing history will be extremely large. Also, for example, if segments having the same type of content are viewed a plurality of times, the same keyword is multiply included in the keyword extracted based on the viewing histories. Therefore, if the number of included keywords is large, there is a great possibility that they are related to a segment in which the viewer is interested.

Given the above, in the present embodiment, only keywords occurring at least a prescribed number of times are extracted as keywords relative to the details of a segment making up a broadcast program watched on the display device 2 holding the identification information. This enables the information processing apparatus 1, for example, to more optimally extract keywords used in selecting advertising to be distributed. Also, the information processing apparatus 1 can select the type of advertising to be distributed to the display device 2 based on the extracted keywords. The prescribed number of times may be pre-established or may be arbitrarily settable.

### Sixth Embodiment

Next, the sixth embodiment of the present invention will be described. The constitution of the information processing system S1 in the present embodiment is the same as the information processing system S1 in the fifth embodiment. The constitutions of the information processing apparatus 1, the display device 2, the viewing history information server apparatus 3, the content distribution server 4, and the program information providing apparatus 5 are the same as the various devices in the fifth embodiment.

The difference in the present embodiment from the fifth embodiment is that, in the present embodiment, the weighting of keywords related to segments viewed for a long period of time is made high, and the weighting of keyword related to segments watched for a short period of time is may low.

For example, even if a segment watched for a short period of time is watched one time, or if a segment viewed for a long period of time is watched one time, the number of occurrences of a keyword in either case is one time. Also, regardless of whether a segment is watched from the start to finish or only watched midway, the number of occurrences of a keyword is one time. However, the longer the viewing time, the greater is the possibility that the segment is a segment of interest to the viewer.

Given the above, in the present embodiment, the weighting of the number of occurrences of a keyword is varied in accordance with the viewing time of the segment. Specifically, the weighting of the number of occurrences of a keyword related to a segment that is watched for a long time is increased, and the weighting of the number of occurrences of a keyword related to a segment that is watched for a short time is decreased.

Then, only keywords that have occurred at least a prescribed number of times are extracted as keywords related to the details of a segment making up a broadcast program watched on the display device 2 holding the identification information. This enables the information processing apparatus 1, for example, to more optimally extract keywords used in selecting advertising to be distributed. The information processing apparatus 1 can select the type of advertising for distribution to the display device 2 based on the extracted keywords. The prescribed number of times may be pre-established or may be arbitrarily settable.

A part or all of the functions of each part of the information processing apparatus 1, the display device 2, the viewing history information server apparatus 3, the content distribution server 4, and the program information providing apparatus 5 in the above noted embodiment may be implemented, in which case, a program to implement those functions is recorded in a computer-readable recording medium, and implementation is done by the program recorded in the recording medium being read into and executed by a computer system. The term “computer system” used here includes an OS (operating system) and hardware such as peripheral devices.

The term “computer-readable recording medium” refers to a removable medium such as a flexible disk, an optomagnetic disk, a ROM (read only memory), a CD-ROM, or the like, or to a storage device such as a hard disk or the like built into a computer system. Additionally, the term “computer-readable recording medium” may encompass one holding a program over a short time dynamically such as a communication line in the case in which a program is transmitted via a network such as the Internet or via a communication line such as a telephone line and one holding a program for a given period of time as a volatile memory within a computer system serving as a server or client. The above-noted program may be for implementing a part of the above-described functionality. Additionally, it may be one enabling implementation by combination with a program that already has recorded the above-noted functionality in a computer system.

Although the foregoing has been a description of the first to the sixth embodiments of the present invention, the present invention is not limited to the above-noted embodiments, and may be subject to various modifications, within the scope of the spirit of the invention.

For example, in the above-described examples, the example used has been that of a broadcast program, in which the content is displayed by the display device 2, this is not a restriction, and the content can be of any type. Also, in the above-described examples, the example of advertising being the content (second content) distributed by the content distribution server 4, the content may be of any type, without restriction.

As used herein, the following directional terms “forward,” “rearward,” “above,” “downward,” “vertical,” “horizontal,” “below,” and “transverse,” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device which includes hardware and/or software that is constructed and/or programmed to carry out the desired function.

The terms of degree such as “substantially,” “about,” and “approximately” as used herein mean a reasonable amount of deviation of the modified term such that the end result is not significantly changed. For example, these terms can be construed as including a deviation of at least ±5 percent of the modified term if this deviation would not negate the meaning of the word it modifies.

It is apparent that the present invention is not limited to the above embodiments, and may be modified and changed without departing from the scope and spirit of the invention.

What is claimed is:

1. An information processing method for an information processing apparatus, the information processing method comprising:
acquiring identification information held by a display device;
acquiring viewing history information indicating a history of content viewed on the display device holding the identification information;
referencing the viewing history information and content detail information describing the details of the content for each segment making up the content; and
extracting searching conditions related to the details of the segment making up the content viewed on the display device holding the identification information.

2. The information processing method according to claim 1, further comprising:
selecting a second content to be distributed to the display device holding the identification information, based on the searching conditions extracted.

3. The information processing method according to claim 1,
wherein extracting the searching conditions comprises:
extracting as the searching conditions, phrases having a high frequency of occurrence in the content detail information of the content viewed on the display device holding the identification information.

4. The information processing method according to claim 3,
wherein extracting the searching conditions comprises:
extracting the searching conditions, while making the weighting of phases occurring in the content detail information higher as the viewing time of the content is longer and making the weighting of phrases occurring in the content detail information lower as the viewing time of the content is lower.

5. The information processing method according to claim 3,
wherein, extracting the searching conditions comprises:
extracting the searching conditions phrases having a low frequency of occurrence in the content detail information of the content viewed on the display device holding the identification information different from the identification information, from the phrases having a high frequency of occurrence in the content detail information of the content viewed on the display device holding the identification information.

6. The information processing method according to claim 1,
wherein extracting the searching conditions comprises:
extracting the searching conditions using the content detail information of the content viewed for a time exceeding a certain time.

7. The information processing method according to claim 1, wherein the identification information held by the display device is peculiar to the display device.

8. The information processing method according to claim 1, wherein the identification information held by the display device is configured to identify a user using the display device.

9. An information processing system comprising:
a display device;
a viewing history information server apparatus; and
an information processing apparatus, wherein
the display device comprises:
a display unit configured to display content,
an identification information storage unit configured to store identification information,
a viewing history transmitting unit configured to transmit viewing history information including a history of watching the content displayed by the display unit and the identification information, and
an identification information transmitting unit configured to transmit the identification information stored by the identification information storage unit;
the viewing history information server apparatus, wherein
the viewing history information server apparatus comprises:
a server receiving unit configured to receive the viewing history information transmitted by the viewing history transmitting unit,
a viewing history storage unit configured to store the viewing history information received by the server receiving unit, and
a server transmitting unit configured to transmit the viewing history information stored by the viewing history storage unit; and
the information processing apparatus, wherein
the information processing apparatus comprises:
an identification information acquisition unit configured to acquire the identification information transmitted from the display device,
a viewing history information acquisition unit configured to acquire the viewing history information transmitted from the viewing history information server apparatus, and
an extraction unit configured to
reference the viewing history information acquired by the viewing history information acquisition unit and content detail information describing the details of the content of each segment make up the content, and
extract search conditions related to the details of the segment making up the content viewed on the display device holding the identification information acquired by the identification information acquisition unit.

10. An information processing method for a display device, the information processing method comprising:
displaying content;
storing identification information;
transmitting viewing history information including a history of watching the content and the identification information;
transmitting the identification information;
receiving a second content selected based on a search condition related to the details of the segment making up the content viewed on its own device, the search condition being extracted by referencing the viewing history information and content detail information describing the detail of the content of each segment making up the content; and
displaying the second content.

11. An information processing method for the display device according to claim 10, comprising:
erasing the display of the second content after a prescribed amount of time has elapsed from the receiving of the second content.
